(19) United States
(12) Patent Application Publication
(10) Pub. No.: US 2009/0219546 A1
(43) Pub. Date: Sep. 3, 2009

(54) Interferometric Gravity Sensor

(75) Inventor: Vincent P. Benischek, Shrub Oak, NY (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/396,316

(22) Filed: Mar. 2, 2009

Related U.S. Application Data
(60) Provisional application No. 61/033,417, filed on Mar. 3, 2008.

(51) Int. Cl. G01B 11/02; G01B 9/02

(52) U.S. Cl. 356/482

(57) ABSTRACT

A system for measuring gravity is disclosed. In the illustrative embodiment, the system uses a pair of retro-reflectors located on a free-falling test mass. These retro-reflectors enable the movement of the test mass to change the length of both a reference arm and sample arm in an interferometer system. As a result, gravity sensors in accordance with the present invention have higher sensitivity than prior-art interferometer-based gravity sensors.

### CROSS REFERENCE TO RELATED APPLICATIONS

This case claims priority to U.S. Provisional Patent Application Ser. No. 61/033,417, filed Mar. 3, 2008 (Attorney Docket: 711-125US), which is incorporated by reference.

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to gravity sensors in general, and, more particularly, to interferometric gravity sensors.

### BACKGROUND OF THE INVENTION

An individual gravity sensor can be used to measure gravity in a local area. A pair of gravity sensors can be used cooperatively to detect a differential gravity between two locations. Multiple differential gravity sensors can be used to develop a three-dimensional map of gravity across a field or other region. Such 3-D mapping has been proposed in order to monitor fluid flow in-situ in subterranean reservoirs, such as oil fields.

In order to be effective in such applications, a gravity sensor must be extremely sensitive. For example, sensitivity below 1 micro-Galileo is often necessary. Such extreme sensitivity, however, requires very high immunity to noise sources. Error can be introduced into the output signal of a gravity sensor from noise sources such as electromagnetic interference, horizontal components in the acceleration of a free-falling mass, mechanical misalignment of sub-components, mechanical shock, and Coriolis forces that arise due to the rotation of the Earth.

Gravity sensors have been developed that are based on the principle of balancing the weight of a fixed mass with forces from a normal or superconducting spring. Gravity sensors such as these, however, can be difficult to setup and calibrate. In addition, such gravity sensors can be sensitive to environmental influences such as temperature or vibration.

Small gravity sensors, specifically designed for direct insertion into areas such as a borehole, have been developed. In some instances, these small gravity sensors utilize piezoelectric launchers to vertically launch a pair of test masses upward so that they can subsequently free-fall downward. An interferometer arrangement is used to monitor the acceleration of their falling masses after each reaches its apex. In addition to some of the drawbacks of other prior-art gravity sensors, the sensitivity of these gravity sensors is limited due to shock and vibration associated with their piezoelectric launchers. This mechanical energy manifests itself as noise into the output signal, reducing signal-to-noise ratio.

There exists a need, therefore, for a gravity sensor that avoids or mitigates some or all of the problems associated with prior-art gravity sensors.

### SUMMARY OF THE INVENTION

The present invention provides a gravity sensor based on an optical interferometer comprising a test mass that includes a retro-reflector pair. Some embodiments of the present invention are particularly well-suited for use in systems such as inertial guidance systems, density measurement systems, and gravity monitors in boreholes of subterranean oil fields.

In some embodiments, a gravity sensor comprises an optical interferometer that is formed by splitting input light into a free-space reference beam and a free-space sample beam. The reference beam is launched into free-space at a reference port and the sample beam is launched into free-space at a sample port. The reference and sample ports are aligned so that the reference beam and sample beam are launched toward each other along an optical axis. A test mass, capable of free-fall along the optical axis, comprises a first retro-reflector and a second retro-reflector. The first retro-reflector reflects the reference beam back toward the reference port. The second retro-reflector reflects the sample beam back toward the sample port. The local gravity at the gravity sensor is determined by monitoring the relative phases of the reflected sample and reference beams as the test mass free-falls along the optical axis.

In prior-art gravity sensors, the free-space path length of a sample beam is directly dependent upon the position of a test mass that falls along an optical axis. In such systems, this sample beam is combined with a fixed-path-length reference beam. The change in the relative phase between the sample beam and reference beam provides an indication of the rate at which the test mass falls and, therefore, a measure of the gravity at the position of the gravity sensor.

Like prior-art gravity sensors, the present invention also provides a sample beam whose free-space path length is directly dependent upon the position of a test mass that falls along an optical axis. In contrast to the prior art, however, the present invention comprises a reference beam whose free-space path length is also directly dependent upon the position of the test mass on the optical axis. As the test mass falls, the free-space path length of the reference beam increases at the same rate that the free-space path length of the sample beam decreases. This effectively doubles the rate at which the phases of the sample beam and reference beam change. As a result, an optical interferometer in accordance with the present invention has sensitivity that can be as much as twice that of prior-art systems.

In an illustrative embodiment, input light is split by a 2×2 splitter/combiner into a reference path and a sample path. Light in the reference path is carried by a first optical fiber to a first gradient-index (GRIN) lens, at which the reference signal is launched into free space. In similar fashion, light in the sample path is carried by a second optical fiber to a second GRIN lens, at which the sample signal is launched into free space. The reference signal is reflected back to the first GRIN lens by a first retro-reflector located on a test mass. The sample signal is reflected back to the second GRIN lens by a second retro-reflector located on the test mass. The reflected reference signal and sample signal are captured at the GRIN lenses and carried to the 2×2 splitter/combiner, where they are combined into a single output light signal. The intensity of this output light signal is based on the relative phases of the reference signal and the sample signal. The phase of each of these signals is based upon the distance between the test mass and each of the two GRIN lenses; therefore, the intensity of the output signal is based upon the position of the test mass.

An embodiment of the present invention comprises: a test mass having a first axis; a first retro-reflector, wherein the first retro-reflector reflects light along a first direction that is aligned with a first reflection axis; and a second retro-reflector, wherein the second retro-reflector reflects light along a second direction that is aligned with a second reflection axis, wherein the first retro-reflector, second retro-reflector, and test mass are physically coupled, and wherein the first reflection axis, second reflection axis, and the first axis are substantially collinear, and further wherein the first direction and second direction are opposite directions.

### BRIEF DESCRIPTION OF THE DRAWINGS

FIG. 1 depicts a schematic diagram of details of an oil field fluid flow measurement system in accordance with an illustrative embodiment of the present invention.

FIG. 2 depicts a schematic diagram of details of a prior-art gravity sensor.

FIG. 3 depicts a gravity sensor in accordance with the illustrative embodiment of the present invention.

FIG. 4 depicts a method for measuring localized gravity at a location in accordance with the illustrative embodiment of the present invention.

### DETAILED DESCRIPTION

The present invention is suitable for use in many applications, including oil field mapping, inertial guidance navigation, and homeland security applications wherein a localized material density measurement might be used to identify hidden cargo or the presence of a secret tunnel. An illustrative embodiment is provided, wherein full-field differential gravity monitoring is used to model the fluid distribution in an oil field by mapping the relative gravity across the expanse of an oil field.

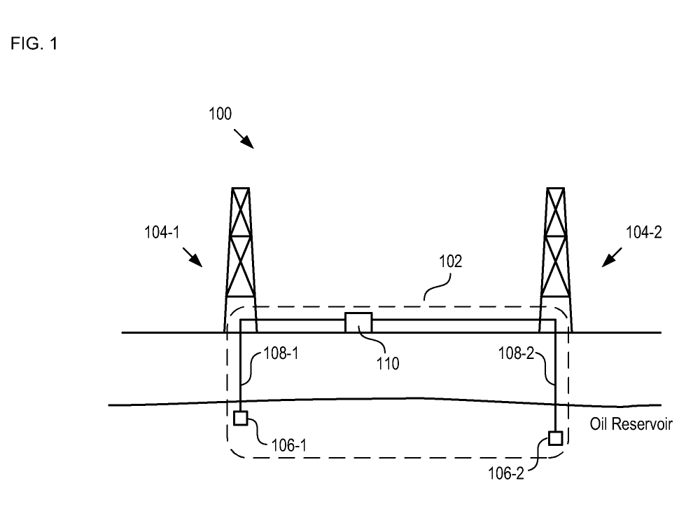

FIG. 1 depicts a schematic diagram of details of an oil field fluid flow measurement system in accordance with an illustrative embodiment of the present invention. Measurement system 100 comprises gravity sensing system 102, and oil wells 104-1 and 104-2.

Gravity sensing system 102 is a system for monitoring fluid movement in the oil field. Gravity sensing system 102 comprises gravity sensors 106-1 and 106-2 (referred to, collectively, as gravity sensors 106), cables 108-1 and 108-2 (referred to, collectively, as cables 108), and processor 110. To monitor fluid flow in the oil field, multiple gravity sensors are inserted directly into the boreholes of oil wells distributed around the oil field. It should be noted that an oil field fluid flow measurement system will typically comprise more than two gravity sensors; however, the illustrative embodiment is depicted with only two gravity sensors for clarity. Each of the gravity sensors provides a signal based on the sensed gravity at its respective location. Processor 110 develops a map of the gravity gradient based on these signals, which provides an indication of the oil distribution through the oil field.

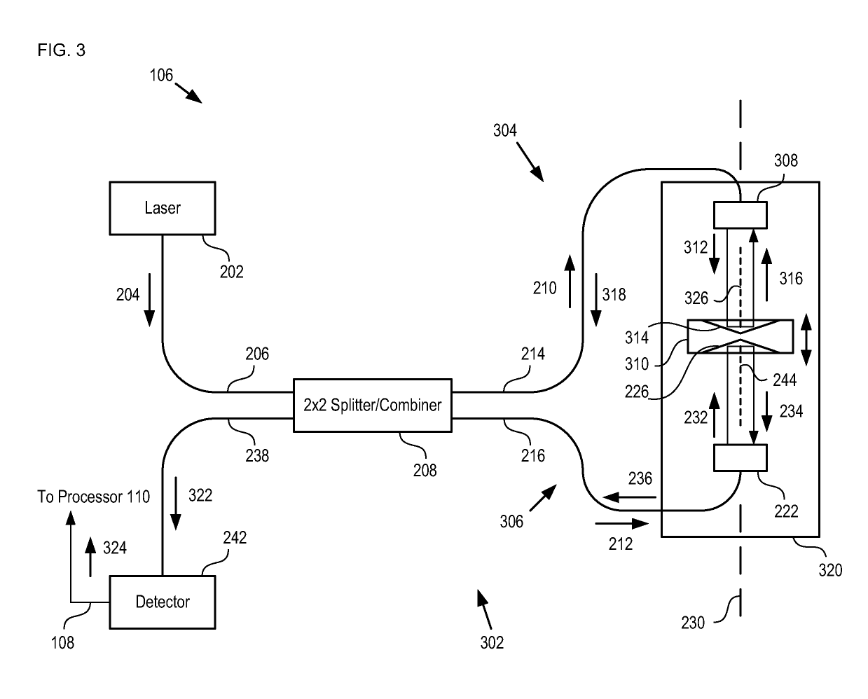

Each of gravity sensors 106 includes a test mass that is enabled to undergo a free fall. The characteristics of the free-fall are based on the gravity at the location of the falling test mass. Each gravity sensor then provides an output signal based on the free-fall of its test mass. These output signals are carried to processor 110 via cables 108. For example, the output signal of gravity sensor 106-2 is carried to processor 110 via cable 108-2. A representative gravity sensor 106 is described in more detail below and with respect to FIG. 3.

Processor 110 is a conventional data processing system for storing data and performing computation. Processor 110 receives output signals from gravity sensors 106-1 and 106-2 and compiles a full-field gravity image based on these output signals. In some embodiments, processor 110 comprises a single laser source for providing input light to each of gravity sensors 106. In some embodiments, processor 110 comprises detectors for receiving output optical signals from one or more of gravity sensors 106.

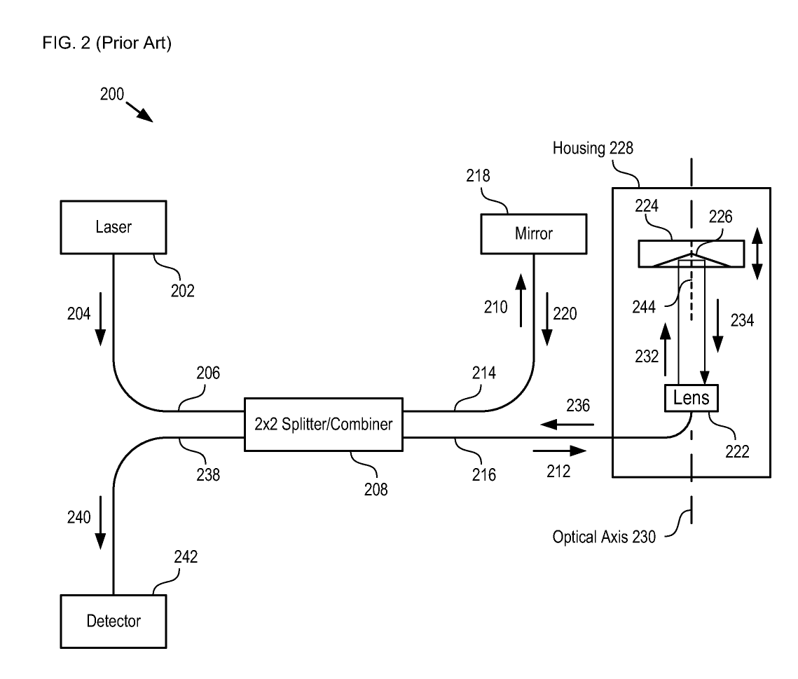

FIG. 2 depicts a schematic diagram of details of a prior-art gravity sensor. Gravity sensor 200 is representative of a class of gravity sensors that are based on interferometric measurement techniques. Gravity sensor 200 comprises laser 202, splitter/combiner 208, mirror 218, lens 222, test mass 224, optical fibers 206, 214, 216, and 238, vacuum chamber 228, and detector 242.

Vacuum chamber 228 protects test mass 224, retro-reflector 226, and lens 222 from its surrounding environment and also enables a vacuum environment that reduces the effect of air resistance on the rate of fall of test mass 224. Vacuum chamber 228 is typically oriented so that when test mass 224 free falls, it travels along axis 230.

In operation, laser 202 provides input light signal 204, which is conveyed to splitter/combiner 208 on optical fiber 206. Input light signal 204 is substantially coherent light that is characterized by a nominal wavelength. Typically, laser 202 is a frequency-stabilized coherent light source, such as a gas laser, semiconductor laser, fiber laser, diode pumped laser, and the like.

Splitter/combiner 208 splits input light signal 204 into reference signal 210 and sample signal 212. Reference signal 210 is conveyed to mirror 218 on optical fiber 214. Sample signal 212 is conveyed to lens 222 on optical fiber 216.

Mirror 218 reflects reference signal 210 back toward splitter/combiner 208 as reflected reference signal 220. Reflected reference signal 220 is conveyed to splitter/combiner 208 on optical fiber 214.

At lens 222, sample signal 212 is launched into free space as free-space sample signal 232, which propagates to retro-reflector 226. Retro-reflector 226 reflects free-space sample signal 232 back to lens 222 as reflected free-space sample signal 234. Retro-reflector 226 receives free-space sample signal 232 along lens optical axis 244 and reflects reflected free-space sample signal 234 back along lens optical axis 244. Lens 222 collects the light contained in reflected free-space sample signal 234 and couples it into optical fiber 216 as reflected sample signal 236. Reflected sample signal 236 is conveyed to splitter/combiner 208 on optical fiber 216.

At splitter/combiner 208, reflected reference signal 220 and reflected sample signal 236 are combined into output optical signal 240. Output optical signal 240 is conveyed on optical fiber 238 to detector 242. Detector 242 generates an electrical signal whose instantaneous value is based on the instantaneous intensity of output optical signal 240. The intensity of output optical signal 240 is based on the interference of reflected reference signal 220 and reflected sample signal 236 when they combine at splitter/combiner 208.

As one skilled in the art will recognize, the interference of reflected reference signal 220 and reflected sample signal 236 occurs as a function of their relative phases at splitter/combiner 208. The phase of each of reflected reference signal 220 and reflected sample signal 236 is the total distance that that signal has traveled (i.e., its total path length).

The total path length traveled by the light contained in reflected reference signal 220 is a fixed distance (i.e., twice the length of optical fiber 214). Since this path length is fixed, the phase of reflected reference signal 220 at splitter/combiner 208 remains fixed.

The total path length traveled by the light contained in sample signal 236 is twice the length of optical fiber 216 (a fixed distance) and the free-space distance traveled by free-space sample signal 232 and reflected free-space sample signal 234. The distance between the reflective surfaces of retro-reflector 226 is disregarded since it is substantially negligible (and fixed). The instantaneous phase of reflected sample signal 236 at splitter/combiner 208, therefore, is based on the instantaneous separation between lens 222 and test mass 224.

During a gravity measurement, test mass 224 is enabled to free-fall along axis 230 toward lens 222. As test mass 224 falls, the phase of reflected sample signal 236 at splitter/combiner 208 changes commensurately. Specifically, the change in phase of reflected sample signal 236 is proportional to twice the change in the separation between lens 222 and retro-reflector 226. As a result, the intensity of output optical signal 240 changes at twice the rate that test mass 224 falls.

Detector 242 receives output optical signal 240 and provides an electrical output signal whose instantaneous value is based on the instantaneous intensity of output optical signal 240. As a result, the electrical output signal is based on the localized gravity that acts on test mass 224.

FIG. 3 depicts a gravity sensor in accordance with the illustrative embodiment of the present invention. Gravity sensor 106 comprises laser 202, splitter/combiner 208, first lens 308, second lens 222, test mass 310, optical fibers 206, 214, 216, and 238, vacuum chamber 320, and detector 242.

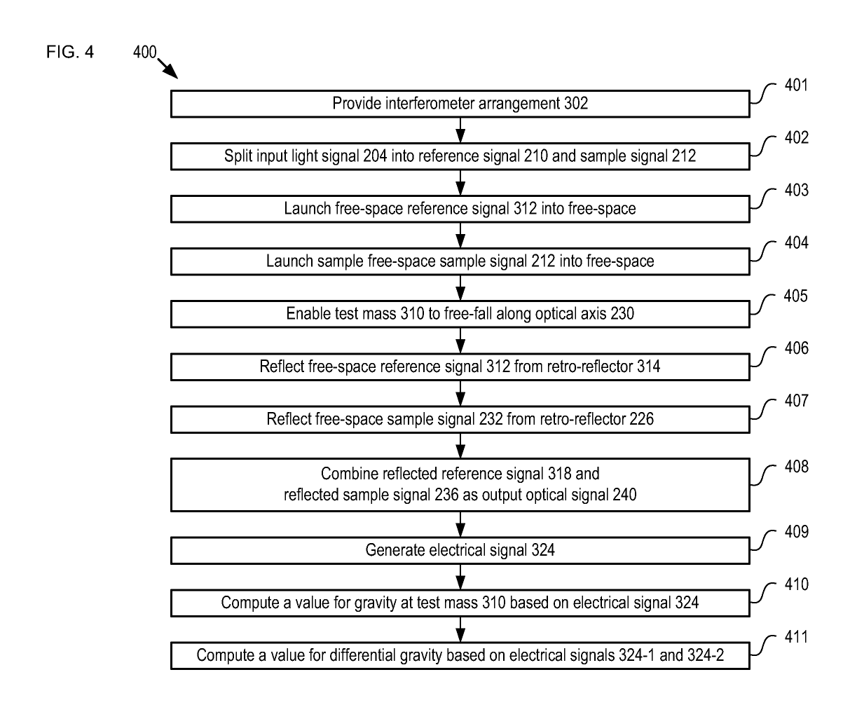

FIG. 4 depicts a method for measuring localized gravity at a location in accordance with the illustrative embodiment of the present invention. Method 400 is described herein with continuing reference to FIGS. 1 and 3.

Method 400 begins with operation 401, wherein interferometer arrangement 308 is provided. Interferometer arrangement 308 comprises source 202, splitter/combiner 208, reference arm 310, sample arm 306, and detector 242.

It should be noted that arms 310 and 306 are designated as “reference arm” and “sample arm” only to facilitate distinguishing them, and optical signals that they convey, from one another. One skilled in the art will recognize, after reading this specification, that these designations are arbitrary and either of arms 310 and 306 can be designated as a reference arm or sample arm.

Reference arm 310 comprises optical fiber 214, lens 308, and the free-space distance between lens 308 and retro-reflector 316. The path length of reference arm 310 comprises twice the length of optical fiber 214, the thickness of lens 308, and twice the separation distance between lens 308 and retro-reflector 316 (neglecting the separation between the reflective surfaces of retro-reflector 316).

In similar fashion, sample arm 306 comprises optical fiber 216, lens 222, and the free-space distance between lens 222 and retro-reflector 226. The path length of sample arm 306 comprises twice the length of optical fiber 216, the thickness of lens 222, and twice the separation distance between lens 222 and retro-reflector 226 (neglecting the separation between the reflective surfaces of retro-reflector 226).

At operation 402, input light signal 204 is split into reference signal 210 and sample signal 212 at splitter/combiner 208. Reference signal 210 is conveyed to lens 308 on optical fiber 214. Sample signal 212 is conveyed to lens 222 on optical fiber 216. Reference signal 210 and sample signal 212 have the same phase as they leave splitter/combiner 208.

Optical fibers 214 and 216 are optically coupled with lenses 308 and 222, respectively, within vacuum chamber 306. Vacuum chamber 320 comprises suitable feed-throughs that enable optical fibers to pass through its outer wall while still enabling vacuum chamber 320 to hold a desired vacuum level (e.g., an internal pressure below 10⁻³ Torr). In some embodiments, vacuum chamber 320 comprises one or more getters to further ensure the maintenance of a suitable vacuum environment within the chamber.

Axis 230 defines the desired axis along which test mass 310 free-falls. Vacuum chamber 320 is oriented so that axis 230 is aligned with the gravity to be sensed. Vacuum chamber 320 comprises a material suitable for supporting a vacuum environment. Suitable materials for vacuum chamber 320 include, without limitation, metals, plastics, glasses, composite materials, and ceramics. It will be clear to one skilled in the art how to make and use vacuum chamber 320.

At operation 403, reference signal 210 is launched into free-space at lens 308 as free-space reference signal 312. Lens 308 substantially collimates free-space reference signal 312. In some embodiments, lens 308 is a conventional GRIN lens affixed at the end of optical fiber 214.

At operation 404, sample signal 212 is launched into free-space at lens 222 as free-space sample signal 232. Lens 222 substantially collimates free-space sample signal 232. In some embodiments, lens 222 is a conventional GRIN lens affixed at the end of optical fiber 216.

As will be clear to one skilled in the art, the relative phases of free-space reference signal 312 and free-space sample signal 212, as they are launched into free-space at their respective lenses, are functions of the path lengths from splitter/combiner 208 to lenses 308 and 222. In some embodiments, these path-lengths are equal so that the phases of free-space reference signal 312 and free-space sample signal 212 are substantially the same as they enter free-space.

At operation 405, a free-fall of test mass 310 along axis 230 is enabled. In some embodiments, the free-fall of test mass 310 is enabled by launching the test mass upward along axis 230 to an apex, at which it begins to free-fall downward along axis 230. In some embodiments, test mass 310 is raised upward along axis 230 and then dropped. It will be clear to one skilled in the art how to enable the free-fall of test mass 310.

Test mass 310 is an object of known mass and comprises retro-reflectors 314 and 226. Retro-reflectors 314 and 226 are conventional corner cube mirrors that are reflective at the wavelength of input light signal 204. Retro-reflector 314 is characterized by optical axis 326, which is collinear with axis 230. Retro-reflector 226 is characterized by optical axis 244, which is also collinear with axis 230. In some embodiments, Axis 230 and optical axes 244 and 326 are aligned with each other, but not collinear. For the purposes of this specification, including the appended claims, axes are considered aligned with each other of they are collinear, or if they are non-collinear but are substantially parallel. In some embodiments, at least one of retro-reflectors 314 and 226 is a different type of retro-reflector, such as a fish-eye retro-reflector, and the like.

At operation 406, free-space reference signal 312 is received from lens 308 along axis 230. Retro-reflector 314 reflects free-space reference signal 312 in an upward direction along axis 230 as reflected free-space reference signal 316. Reflected free-space reference signal 316 is captured by lens 314 and coupled into optical fiber 214 as reflected reference signal 318. Optical fiber 214 conveys reflected reference signal 318 to splitter/combiner 208.

The phase of reflected reference signal 318 at splitter/combiner 208 depends upon the total path length of reference arm 304. Since the length of optical fiber 214 is fixed, a change in the phase of reflected reference signal 318 at splitter/combiner 208 depends only on a change in the position of retro-reflector 314 (and, therefore, the position of test mass 310) along axis 230.

At operation 407, free-space sample signal 232 is received from lens 222 along axis 230. Retro-reflector 226 reflects free-space sample signal 232 in a downward direction along axis 230 as reflected free-space sample signal 234. Reflected free-space sample signal 234 is captured by lens 222 and coupled into optical fiber 216 as reflected sample signal 236. Optical fiber 216 conveys reflected sample signal 236 to splitter/combiner 208.

The phase of reflected sample signal 236 at splitter/combiner 208 depends upon the total path length of sample arm 306. Since the length of optical fiber 216 is fixed, a change in the phase of reflected sample signal 236 at splitter/combiner 208 depends only on a change in the position of retro-reflector 226 (and, therefore, the position of test mass 310) along axis 230.

At operation 408, reflected reference signal 318 and reflected sample signal 236 are combined as output optical signal 322. Reflected reference signal 318 and reflected sample signal 236 will combine either constructively or destructively depending on their relative phases. The instantaneous intensity of output optical signal 322, therefore, is based on the relative instantaneous phases of reflected reference signal 318 and reflected sample signal 236.

At operation 409, detector 242 receives output optical signal 322 and generates output signal 324. The instantaneous value of output signal 324 corresponds to the instantaneous intensity of output optical signal 322. Output signal 324 is conveyed to processor 110 on cable 108.

An aspect of the present invention is that the distance between lens 308 and retro-reflector 314 increases at the same rate that the distance between lens 222 and retro-reflector 226 decreases as test mass 310 falls along axis 230. As a result, the rate at which the intensity of output optical signal 322 changes is twice the rate of the phase change of each of reflected reference signal 310 and reflected sample signal 232. Since the phase of each of reflected reference signal 310 and reflected sample signal 232 changes at twice the rate at which test mass 310 falls, the intensity of output optical signal 322 changes at four times the rate at which test mass 310 falls. As discussed above, and with respect to FIG. 2, the rate of change of the intensity of output signal 240 based on falling test mass 224. The sensitivity of gravity sensor 106 to gravity at the location of test mass 310, therefore, is twice that of prior art systems that rely on a fixed phase reference signal.

At operation 410, processor 110 receives output signal 324 and computes a value for gravity at the location of test mass 310.

At operation 411, processor 110 computes a value for the difference in gravity at the locations of gravity sensors 106-1 and 106-2 (i.e., test masses 310-1 and 310-2).

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An apparatus comprising:
a first test mass having a first axis, wherein the first test mass comprises a first physical adaptation that enables the first test mass to free-fall along a direction that is aligned with the first axis;
a first retro-reflector, wherein the first retro-reflector reflects light along a first direction that is aligned with a first reflection axis, and wherein the first reflection axis is aligned with the first axis; and
a second retro-reflector, wherein the second retro-reflector reflects light along a second direction that is aligned with a second reflection axis, and wherein the second reflection axis is aligned with the first axis;
wherein the first retro-reflector, second retro-reflector, and first test mass are physically coupled, and wherein the first direction and second direction are opposite directions.

2. The apparatus of claim 1 wherein the first reflection axis, second reflection axis, and the first axis are substantially collinear.

3. The apparatus of claim 1 further comprising a vacuum chamber, wherein the vacuum chamber encloses the test mass, first retro-reflector, and second retro-reflector.

4. The apparatus of claim 1 further comprising:
a source of light, wherein the light is characterized by a wavelength;
a beam splitter; and
a photodetector;
wherein the beam splitter distributes light from the source into a first light signal and a second light signal;
wherein the beam splitter receives a third light signal that is based on the first light signal and a position of the first retro-reflector;
wherein the beam splitter receives a fourth light signal that is based on the second light signal and a position of the second retro-reflector; and
wherein the photodetector generates an electrical output signal based on a combination of the third light signal and the fourth light signal.

5. The apparatus of claim 4 further comprising:
a first optical fiber, wherein the first optical fiber conveys the first light signal and the third light signal;
a second optical fiber wherein the second optical fiber conveys the second light signal and the fourth light signal;
a first lens that is optically coupled with the first optical fiber, wherein the first lens provides the first light signal to the first retro-reflector as a first free-space light signal, and wherein the first lens couples a second free-space light signal from the first retro-reflector into the first optical fiber as the third light signal; and
a second lens that is optically coupled with the second optical fiber, wherein the second lens provides the second light signal to the second retro-reflector as a third free-space light signal, and wherein the second lens couples a fourth free-space light signal from the second retro-reflector into the second optical fiber as the fourth light signal.

6. The apparatus of claim 1 further comprising a launcher for propelling the test mass along one of the first direction and second direction.

7. The apparatus of claim 1 further comprising:
a second test mass having a second axis, wherein the second test mass comprises a second physical adaptation that enables the second test mass to free-fall along a direction that is aligned with the second axis;
a third retro-reflector, wherein the third retro-reflector reflects light along a third direction that is aligned with a third reflection axis, and wherein the third reflection axis is aligned with the second axis; and
a fourth retro-reflector, wherein the fourth retro-reflector reflects light along a fourth direction that is aligned with a fourth reflection axis, and wherein the fourth reflection axis is aligned with the second axis;
wherein the third retro-reflector, fourth retro-reflector, and second test mass are physically coupled, and wherein the third direction and fourth direction are opposite directions.

8. A method comprising:
enabling a free-fall of a test mass along a first axis, wherein the test mass comprises a first retro-reflector and a second retro-reflector;
receiving a first light signal at the first retro-reflector, wherein the first light signal is received along a first direction that is substantially aligned with the first axis;
receiving a second light signal at the second retro-reflector, wherein the second light signal is received along a second direction that is substantially aligned with the first axis, and wherein the first direction and the second direction are opposite directions;
combining a third light signal and a fourth light signal to form a fifth light signal, wherein the third light signal is based on the first light signal and a position of the first retro-reflector, and wherein the fourth light signal is based on the second light signal and a position of the second retro-reflector;
providing an electrical output signal based on the fifth light signal; and
generating a value for gravity at the location of the test mass, wherein the value is based on the electrical output signal.

9. The method of claim 8 wherein the free-fall of the test mass is enabled by propelling the test mass along one of the first direction and the second direction to an apex.

10. The method of claim 8 further comprising:
splitting light from a source into a sixth light signal and a seventh light signal, wherein the first light signal is based on the sixth light signal and the second light signal is based on the seventh light signal.

11. The method of claim 8 further comprising providing the test mass, first retro-reflector, and second retro-reflector such that the first axis, first direction, and second direction are substantially collinear.

12. The method of claim 8 further comprising providing the first light signal as a free-space light signal.

13. The method of claim 12 further comprising providing the second light signal as a free-space light signal.

14. A method comprising:
providing a first interferometer arrangement having a first arm and a second arm, wherein the length of the first arm is based on a position of a first test mass along a first axis, and wherein the length of the second arm is based on the position of the first test mass along the first axis;
enabling the free-fall of the first test mass along the first axis;
providing a first electrical signal that is based on a first change in the length of the first arm and a second chance in the length of the second arm; and
generating a first value for gravity at the location of the first test mass, wherein the first value is based on the first electrical signal.

15. The method of claim 14 further comprising orienting the first axis based on a first gravity field.

16. The method of claim 14 further comprising enclosing the first test mass in a vacuum chamber.

17. The method of claim 14 further comprising:
reflecting a first free-space light signal from a first retro-reflector as a second free-space light signal, wherein the first free-space light signal propagates in free-space for a first path-length and the second free-space light signal propagates in free-space for a second path-length, and wherein the length of the first arm comprises the first path-length and the second path-length;
reflecting a third free-space light signal from a second retro-reflector as a fourth free-space light signal, wherein the third free-space light signal propagates in free-space for a third path-length and the fourth free-space light signal propagates in free-space for a fourth path-length, and wherein the length of the second arm comprises the third path-length and the fourth path-length;
combining the second free-space light signal and the fourth free-space light signal; and
receiving the combined second free-space light signal and fourth free-space light signal at a photodetector, wherein the photodetector generates the first electrical signal, and wherein the first electrical signal is based on the intensity of the combined second free-space light signal and fourth free-space light signal;
wherein the first test mass comprises the first retro-reflector and the second retro-reflector.

18. The method of claim 14 further comprising:
splitting light from a source into a first light signal and a second light signal, wherein the light is characterized by a wavelength;
launching the first light signal into free-space as a first free-space light signal;
reflecting the first free-space light signal from a first retro-reflector as a second free-space light signal, wherein the first free-space light signal propagates in free-space for a first path-length and the second free-space light signal propagates in free-space for a second path-length, and wherein the length of the first arm comprises the first path-length and the second path-length;
coupling the second free-space light signal into an optical fiber as a third light signal;
launching the second light signal into free-space as a third free-space light signal;
reflecting the third free-space light signal from a second retro-reflector as a fourth free-space light signal, wherein the third free-space light signal propagates in free-space for a third path-length and the fourth free-space light signal propagates in free-space for a fourth path-length, and wherein the length of the second arm comprises the third path-length and the fourth path-length;
coupling the fourth free-space light signal into an optical fiber as a fourth light signal;
combining the third light signal and the fourth light signal into a fifth light signal; and
receiving the fifth light signal at a photodetector, wherein the photodetector generates the first electrical signal, and wherein the first electrical signal is based on the intensity of the fifth light signal;
wherein the first test mass comprises the first retro-reflector and the second retro-reflector.

19. The method of claim 14 further comprising:
providing a second interferometer arrangement having a third arm and a fourth arm, wherein the length of the third arm is based on a position of a second test mass along a second axis, and wherein the length of the fourth arm is based on the position of the second test mass along the second axis;
enabling the free-fall of the second test mass along the second axis;
providing a second electrical signal that is based on a third change in the length of the third arm and a fourth change in the length of the fourth arm; and
generating a second value for gravity at the location of the second test mass, wherein the second value is based on the second electrical signal.

20. The method of claim 19 further comprising generating a difference in the gravity at the location of the first test mass and the gravity at the location of the second test mass, wherein the difference is based on the first value and the second value.
